(19) United States
(12) Patent Application Publication
(10) Pub. No.: US 2015/0267874 A1
(43) Pub. Date: Sep. 24, 2015

(54) LIGHT SOURCE DEVICE

(71) Applicant: SHARP KABUSHIKI KAISHA, Osaka-shi, Osaka (JP)

(72) Inventor: Noriaki Terazawa, Osaka-shi (JP)

(73) Assignee: SHARP KABUSHIKI KAISHA, Osaka-shi, Osaka (JP)

(21) Appl. No.: 14/434,352

(22) PCT Filed: Sep. 2, 2013
(86) PCT No.: PCT/JP2013/073474

§ 371 Date: Apr. 8, 2015

(30) Foreign Application Priority Data
Nov. 2, 2012 (JP) 2012-242983

(51) Int. Cl. F21K 99/00; F21V 23/00

(52) U.S. Cl. CPC F21K 9/175; F21V 23/005; F21Y 2103/003

(57) ABSTRACT

A light source device includes a tubular translucent cover. At one end side of the translucent cover, a translucent terminal fixing part to which one ground terminal is fixed is attached. At another end side of the translucent cover, a translucent terminal fixing part to which two power feeding terminals are fixed is attached. Inside the translucent cover, a placement plate is arranged, and a substrate is placed on the placement plate. On one surface (front surface) of the substrate, LED modules are mounted as a plurality of light sources. The LED modules mounted at ends of the substrate are located inside the terminal fixing parts. At another surface of the substrate located inside the terminal fixing part, a circuit component is mounted.

### CROSS-REFERENCE TO RELATED APPLICATIONS

This application is the national phase under 35 U.S.C. §371 of PCT International Application No. PCT/JP2013/073474 which has an International filing date of Sep. 2, 2013 and designated the United States of America. (US only)

### TECHNICAL FIELD

The present invention relates to a light source device including a substrate on which a light source is mounted, and a tubular translucent cover in which the substrate is installed.

### BACKGROUND ART

In recent years, along with the increased luminance of a light emitting diode (LED), an LED having properties of low power consumption, long service life and the like has gradually been employed as a light source in an illumination apparatus in place of a conventional light source such as an incandescent light bulb or a fluorescent light.

For example, as a substitute for a straight tube fluorescent lamp, a straight tube LED lamp (light source device) has been made into a product in which a white LED is mounted on a substrate which is covered by a cylindrical translucent cover provided with a power receiving base having a power receiving pin at one end of the cover and a grounding base having a grounding pin at the other end of the cover.

For example, an LED lamp including a straight tube, a station located in the straight tube, a mounting substrate placed on the station and an LED mounted on the mounting substrate, is disclosed, in which a power receiving base is attached to one end of the straight tube, a grounding base is attached to the other end of the straight tube, and a circuit board on which circuit elements such as a diode bridge and the like are mounted is located inside the power receiving base (see Japanese Patent Application Laid-Open Publication No. 2012-99414).

### SUMMARY

In the LED lamp of Japanese Patent Application Laid-Open Publication No. 2012-99414, however, the base attached to each end of the straight tube is configured to cover the end of the straight tube, so that the light emitted by the LED is not transmitted through the base. Moreover, since a circuit board on which circuit elements such as a diode bridge is mounted is located inside a power receiving base, the portion of the base does not function as a portion for emitting light.

In other words, a portion not capable of emitting light is present at each end of the straight tube, which causes a problem in that a light emitting region is narrowed for the LED lamp as a whole.

The present invention has been made in view of the circumstances described above, and aims to provide a light source device capable of widening a light emitting region.

A light source device according to the present invention is characterized by comprising a substrate on which a plurality of light sources are mounted, and a tubular translucent cover in which the substrate is installed, and is characterized in that a part of the light sources is mounted on one surface of an end of the substrate, and a circuit component is provided on the side of another surface at the end of the substrate.

The light source device according to the present invention is characterized in that the circuit component is mounted on another surface at the end of the substrate, the light source device comprises a placement plate on which the substrate is placed, and the placement plate has an opening at a portion opposed to the circuit component.

The light source device according to the present invention is characterized by comprising, at an end provided with the circuit component of the translucent cover, a terminal fixing part having translucency to which a power feeding terminal or a ground terminal is fixed.

The light source device according to the present invention is characterized in that the translucent cover includes a fitted part at an end of the translucent cover, the terminal fixing part includes a fitting part to be fitted with the fitted part, the fitted part has a thin first fitted part and a thick second fitted part extending from the first fitted part, and the fitting part has a thick first fitting part and a thin second fitting part to be fitted with the first fitted part and the second fitted part, respectively.

The light source device according to the present invention is characterized in that the circuit component has a plurality of rectifying elements, and the plurality of rectifying elements are separately provided at an input side and an output side of the light source on the substrate.

According to the present invention, the light emitting region can be widened.

The above and further objects and features of the invention will more fully be apparent from the following detailed description with accompanying drawings. (US Only)

### BRIEF DESCRIPTION OF SEVERAL VIEWS OF DRAWINGS

FIG. 1 is a side view illustrating an example of an outer appearance of a light source device according to an embodiment of the present invention;

FIG. 2 is a section view on the side surface side illustrating an example of a configuration of a light source device according to an embodiment of the present invention;

FIG. 3 is a section view taken along the line in FIG. 2;

FIG. 4 is a plan view of one surface side of a substrate;

FIG. 5 is a plan view of another surface side of the substrate;

FIG. 6 is a plan view illustrating an example of a placement plate;

FIG. 7 is a schematic view illustrating the first example of a fitting part between a terminal fixing part and a translucent cover;

FIG. 8 is a schematic view illustrating the second example of a fitting part between a terminal fixing part and a translucent cover;

FIG. 9 is a schematic view illustrating the third example of a fitting part between a terminal fixing part and a translucent cover;

FIG. 10 is a schematic view illustrating the fourth example of a fitting part between a terminal fixing part and a translucent cover;

FIG. 11 is a schematic view illustrating the fifth example of a fitting part between a terminal fixing part and a translucent cover;

FIG. 12 is a plan view illustrating another example of another surface side of a substrate;

FIG. 13 is a schematic view illustrating an example of a layout of a substrate;

FIG. 14 is a schematic view illustrating an example of a temperature distribution for a translucent cover;

FIG. 15 is a schematic view illustrating an example of a layout for mounting LED modules to a substrate as a comparative example;

FIG. 16 is a schematic view illustrating an example of a layout for mounting LED modules to a substrate according to an embodiment of the present invention; and

FIG. 17 is a schematic view illustrating an example of brightness distribution for a translucent cover.

### DETAILED DESCRIPTION

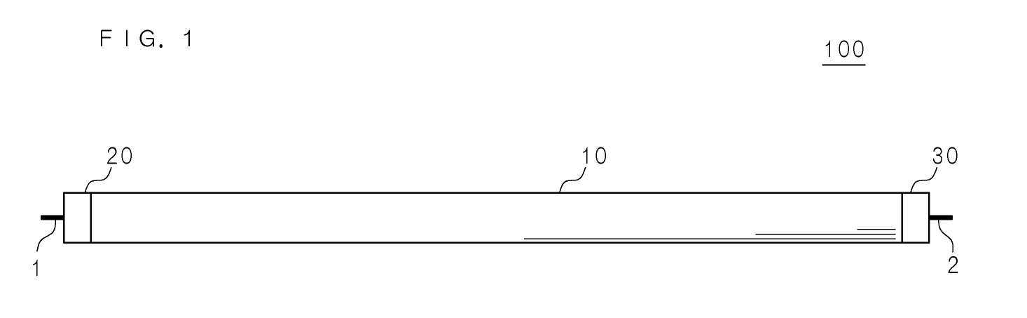

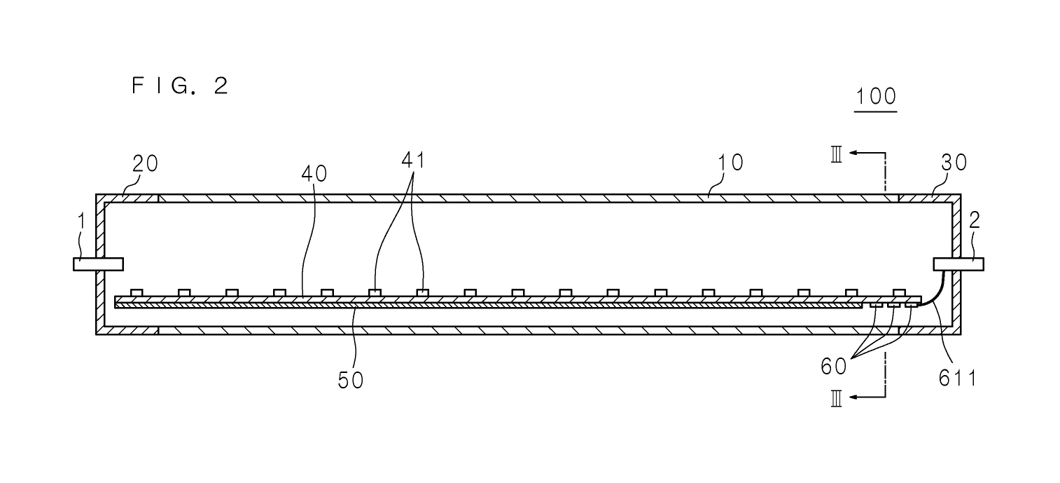

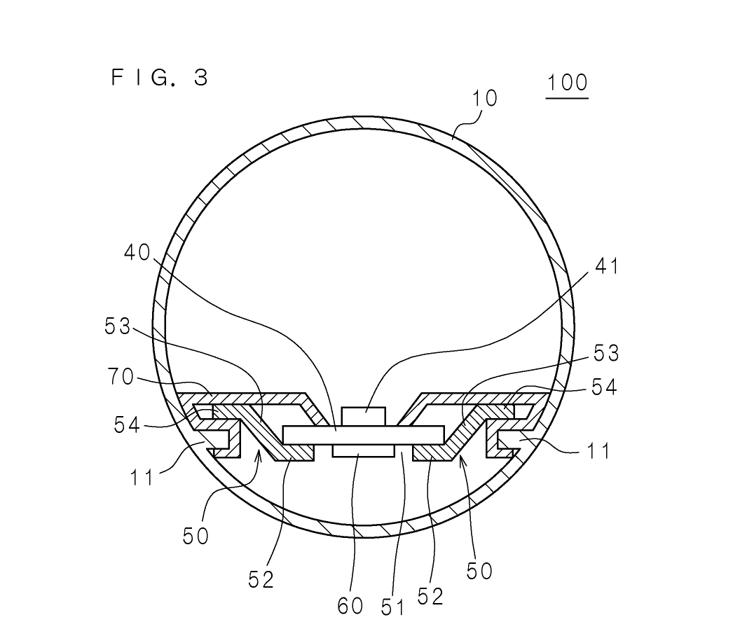

The present invention will now be described with reference to the drawings illustrating an embodiment thereof. FIG. 1 is a side view illustrating an example of the outer appearance of a light source device 100 according to an embodiment of the present invention, FIG. 2 is a side section view illustrating an example of a configuration of the light source device 100 according to the present embodiment, and FIG. 3 is a section view taken along the line in FIG. 2. The light source device 100 according to the present embodiment is, for example, a straight tube lamp which is a substitute for the conventional 40 W straight fluorescent lamp, and is attached to a lamp socket (not illustrated) provided in an illumination apparatus main body (lamp fitting). It is to be noted that the wattage is not limited to 40 W but may be another wattage such as 20 W, 100 W or the like.

The light source device 100 includes a tubular (e.g., cylindrical) translucent cover 10. At one end side of the translucent cover 10, a terminal fixing part 20 to which one ground terminal 1 is fixed is attached. Furthermore, at the other end side of the translucent cover 10, a terminal fixing part 30 to which two power feeding terminals 2 are fixed is attached. Each of the terminal fixing parts 20 and 30 forms a cylindrical shape having a bottom surface at an end on one side thereof.

The translucent cover 10 is made of synthetic resin which is excellent in weather resistance and translucency, and has a high light-extraction efficiency. For example, polycarbonate may be used for the translucent cover 10. Moreover, as in the translucent cover 10, the terminal fixing parts 20 and 30 may also be made of, for example, polycarbonate which is synthetic resin having excellent weather resistance and translucency and also having a high light-extraction efficiency. It is to be noted that the translucent cover 10, terminal fixing parts 20 and 30 may have a color of, for example, semi-transparent opaque white.

As illustrated in FIG. 2, inside the translucent cover 10, a placement plate 50 having a rectangular (e.g., oblong) shape in a plan view is arranged along the longitudinal direction (axis direction of the straight tube) of the translucent cover 10, while a substrate 40 of a rectangular (e.g., oblong) shape in a plan view is placed on the placement plate 50. On one surface (front surface) of the substrate 40, LED modules 41 are mounted as light sources. It is also possible to arrange more than one substrates 40 side by side in accordance with the length of the translucent cover 10. The LED module 40 is a white-colored LED module, which can emit, for example, light of a daylight color.

The substrate 40 has a length substantially corresponding to the length of the translucent cover 10 added by the lengths of the terminal fixing parts 20 and 30. In other words, the ends of the substrate 40 are located at the inner sides of the terminal fixing parts 20 and 30. The LED modules 41 mounted at the ends of the substrate 40 are also located inside the terminal fixing parts 20 and 30. That is, the ends of the substrate 40 as well as the LED modules 41 are inserted into cylindrical cavities formed by the terminal fixing parts 20 and 30.

On another surface (rear surface, also referred to as “the other surface”) of the substrate 40 located inside the terminal fixing part 30, circuit components 60 are mounted. That is, the terminal fixing part 30 is located at the end of the translucent cover 10 where the circuit components 60 are provided. The circuit components 60 include electric or electronic components such as a rectifying element like a diode bridge, a protection element like a fuse or varistor, a resistor element and a connector. A wiring 611 is connected between the connecter and power feeding terminal 2. Note that the rectifying element is to allow voltage having a correct polarity to be applied to the LED modules 41 regardless of the polarity, i.e. positive or negative, of direct current voltage fed from the outside being connected to either one of two power feeding terminals 2.

Though the example in FIG. 2 illustrates a configuration where the circuit components 60 are directly mounted on the other surface (rear surface) of the substrate 40, it is not limited to the illustrated configuration but may also include a circuit board (not illustrated) separately arranged on the other surface side of the substrate 40 and the circuit component 60 may be mounted on the separate circuit board. In the case where the separate circuit board is used, a cutout 51 as an opening at the placement plate 50, which will be described later, is unnecessary.

As illustrated in FIG. 3, inside the translucent cover 10, at a position shifted toward the inner circumferential surface side of the translucent cover 10 from the center (e.g., central axis) of the translucent cover 10, the substrate 40 with one surface on which an LED module 41 is mounted, the placement plate 50 on which the substrate 40 is placed, and a support 70 for supporting the placement plate 50 to attach it to the translucent cover 10 are arranged.

Furthermore, the substrate 40 is so arranged that the light emitting direction of the LED module 41 is directed to the center of the translucent cover 10. In other words, the substrate 40 is so arranged that one surface of the substrate 40 on which the LED module 41 is mounted is directed to the center of the translucent cover 10.

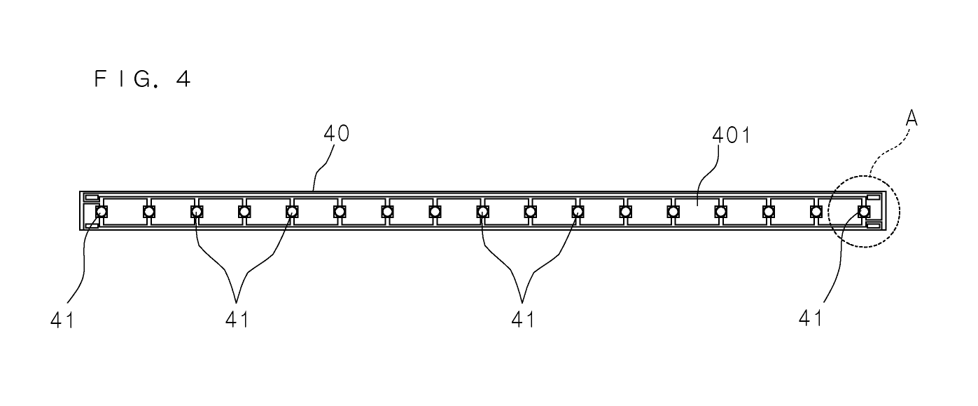

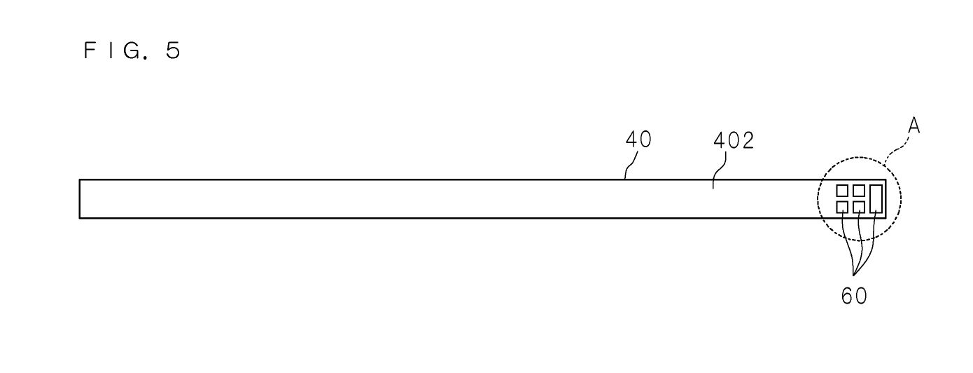

FIG. 4 is a plan view of one surface side of the substrate 40, whereas FIG. 5 is a plan view of another surface side of the substrate 40. As illustrated in FIG. 4, a plurality of LED modules 41 are mounted on one surface (front surface) 401 of the substrate 40. In particular, an LED module 41 is also mounted at an end of the substrate 40 enclosed by a dashed line indicated by a reference code A. As illustrated in FIG. 5, on another surface (rear surface) 402 of the end of the substrate 40 enclosed by the dashed line indicated by the reference code A, the circuit components 60 described earlier are mounted. The end of the substrate 40 indicated by the reference code A is arranged inside the terminal fixing part 30. The material for the substrate 40 may be aluminum or may also be resin.

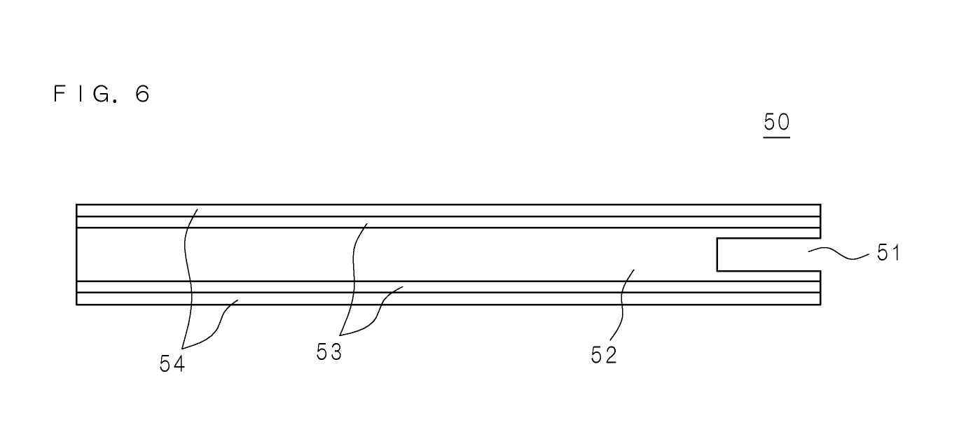

FIG. 6 is a plan view illustrating an example of the placement plate 50. The placement plate 50 is a plate member made of metal such as aluminum or iron, for example, and functions as a heat conducting plate. The material used for the placement plate 50 is not limited to the metal material described above, but may also be another material with preferable thermal conductivity such as ceramic. In other words, the placement plate 50 is for conducting heat from the LED module 41.

As illustrated in FIGS. 3 and 6, the placement plate 50 has a placement part 52 on which the substrate 40 is placed, and side plates 53 inclined and extending from the long sides of the placement part 52. The placement plate 50 has a substantially rectangular shape, the length of the placement part 52 is approximately the same as the length of the substrate 40 (in the case of more than one substrates 40, the sum of the lengths of substrates 40), and the width of the placement part 52 is made wider than the width of the substrate 40.

Moreover, at an edge part of the side plate 53, a bent part 54 is formed, which is so bent as to be substantially in parallel with the placement part 52. Furthermore, as illustrated in FIG. 6, at an end of the placement plate 50, a rectangular cutout 51 is formed as an opening. The cutout 51 corresponds to the mounting region of the circuit components 60 mounted on the other surface 402 of the substrate 40, and the circuit components 60 described above are arranged in the cutout 51 in the state where the substrate 40 is placed on the placement plate 50. That is, the placement plate 50 has the cutout 51 as an opening at a portion opposed to the circuit components 60.

As illustrated in FIG. 3, the translucent cover 10 includes protrusions 11 opposed to each other at the inner circumference along the longitudinal direction of the translucent cover 10.

The support 70 is made of synthetic region, and may be fabricated by press molding using, for example, PBT (polyethylene terephthalate). It is to be noted that the material for the support 70 is not limited to PBT, but may be any other material which can easily be molded and has high heat resistance. Furthermore, the support 70 may preferably be made of a material having low thermal conductivity.

The support 70 has a length and width approximately the same as those of the placement plate 50. The support 70 is fixed inside the translucent cover 10 by being fitted with the protrusion 11 formed on the inner circumference of the translucent cover 10, and pinches and holds the bent part 54 of the placement plate 50 while being in contact with the front surface of the substrate 40 placed on the placement plate 50, so as to support the placement plate 50 and substrate 40.

As described above, according to the present embodiment, a part of the LED modules 41 are mounted on one surface 401 at an end of the substrate 40, whereas the circuit components 60 are provided on the side of the other surface 402 at the end of the substrate 40. That is, the LED module 41 is also arranged inside the translucent terminal fixing part 30, which allows the portion corresponding to a so-called base of the conventional straight tube lamp to also emit light, unlike the conventional straight tube lamp, making it possible to provide a wider light emitting region in the longitudinal direction of the light source device 100. Moreover, as the number of the LED modules 41 to be mounted on the light source device 100 may be increased, the luminous flux may be made higher while the irradiated area may be wider by the portion corresponding to the length of the terminal fixing part 30. Likewise, the LED module 41 also being arranged inside the translucent terminal fixing part 20 can further make the light emitting region wider and the luminous flux higher, while the irradiated area may be wider by the portion corresponding to the length of the terminal fixing part 20. In particular, the LED modules 41 are mounted on one surface 401 of the substrate 40 opposed to the mounting region on which the circuit components 60 are mounted, eliminating the problem of the light emitting region being narrower because of the circuit components 60.

Furthermore, in the present embodiment, the circuit components 60 are mounted on the other surface 402 at an end of the substrate 40, and the placement plate 50 having the cutout 51 is arranged in the region where the circuit components 60 are mounted. That is, by forming the cutout 51 at the placement plate 50, the substrate 40 can be placed in the state where the circuit components 60 are mounted on the other surface (rear surface) 402 of the substrate 40. It is also possible to form a through hole as an opening at an end of the placement plate, not limited to the cutout according to the present embodiment, as long as the placement of the circuit components 60 is not hindered by the placement plate 50.

Furthermore, in the present embodiment, by providing the translucent terminal fixing part 30 to which the power feeding terminal 2 is fixed and the translucent terminal fixing part 20 to which the ground terminal 1 is fixed, the portion corresponding to a so-called base can also emit light unlike the conventional straight tube lamp, which can make the light emitting region wider. Moreover, since the conventional base not transmitting light therethrough is not present, there is no dark part from which light is not emitted, allowing for a so-called full-face light emission.

Next, a method of fitting the terminal fixing parts 20 and 30 with the translucent cover 10 will be described. While the method of fitting the terminal fixing part 20 with the translucent cover 10 will be described in the example below, a similar method may be applied for fitting the terminal fixing part 30 with the translucent cover 10.

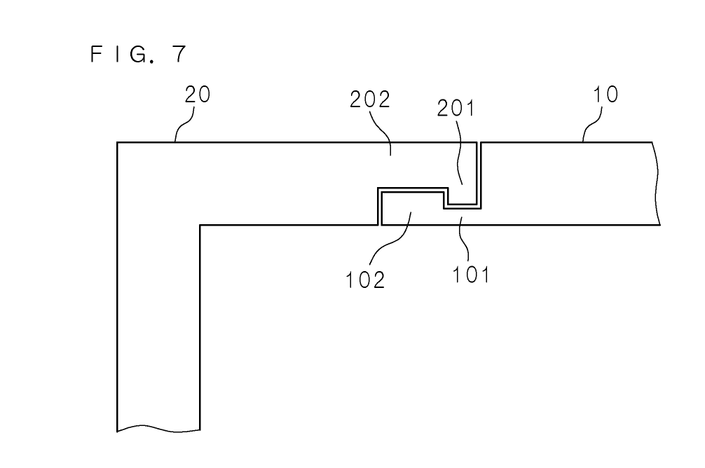

FIG. 7 is a schematic view illustrating the first example of a fitting part between the terminal fixing part 20 and the translucent cover 10. The example in FIG. 7 illustrates the case where an end of the terminal fixing part 20 is fitted onto an end of the translucent cover 10. As illustrated in FIG. 7, the translucent cover 10 includes a fitted part at the end thereof, the fitted part having a thin first fitted part 101 and a thick second fitted part 102 extending from the first fitted part 101 to the end side. Furthermore, the terminal fixing part 20 includes a fitting part to be fitted with the fitted part of the translucent cover 10, the fitting part having a thick first fitting part 201 to be fitted with the first fitted part 101, and a thin second fitting part 202 to be fitted with the second fitted part 102.

Accordingly, the first fitting part 201 is fitted with the first fitted part 101 while the second fitting part 202 is fitted with the second fitted part 102, so that the terminal fixing part 20 can be attached to the translucent cover 10 without using an adhesive or a component such as a screw, thereby reducing the number of assembling works and enhancing the assembling performance.

Moreover, as the thick second fitted part 102 and the thick first fitting part 201 are in contact with each other, the terminal fixing part 20 can be restricted from coming off from the translucent cover 10, further securing the fitting. A similar manner applies to the terminal fixing part 30, which will not be described here.

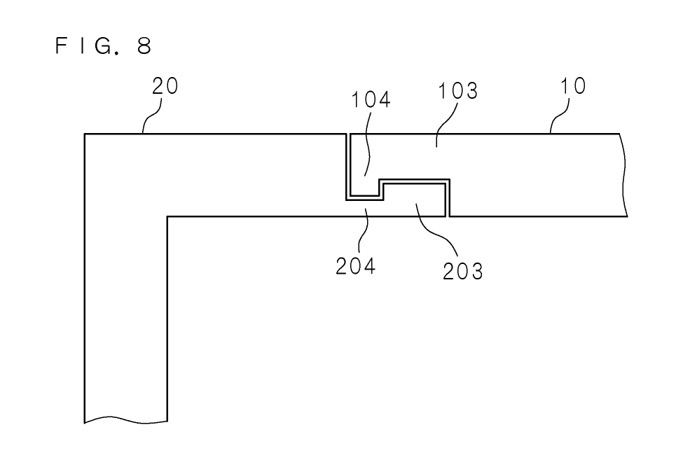

FIG. 8 is a schematic view illustrating the second example of a fitting part between the terminal fixing part 20 and the translucent cover 10. The example in FIG. 8 illustrates the case where an end of the translucent cover 10 is fitted onto an end of the terminal fixing part 20. As illustrated in FIG. 8, the translucent cover 10 includes a fitted part at an end thereof, and the fitted part has a thin first fitted part 103 and a thick second fitted part 104 extending from the first fitted part 103 to the end side. Moreover, the terminal fixing part 20 includes a fitting part to be fitted with the fitted part of the translucent cover 10, and the fitting part has a thick first fitting part 203 to be fitted with the first fitted part 103 and a thin second fitting part 204 to be fitted with the second fitted part 104.

Accordingly, the first fitting part 203 is fitted with the first fitted part 103 while the second fitting part 204 is fitted with the second fitted part 104, so that the terminal fixing part 20 can be attached to the translucent cover 10 without using an adhesive or a component such as a screw, thereby reducing the number of assembling works and enhancing the assembling performance.

Moreover, as the thick second fitted part 104 and the thick first fitting part 203 are in contact with each other, the terminal fixing part 20 can be restricted from coming off from the translucent cover 10, further securing the fitting.

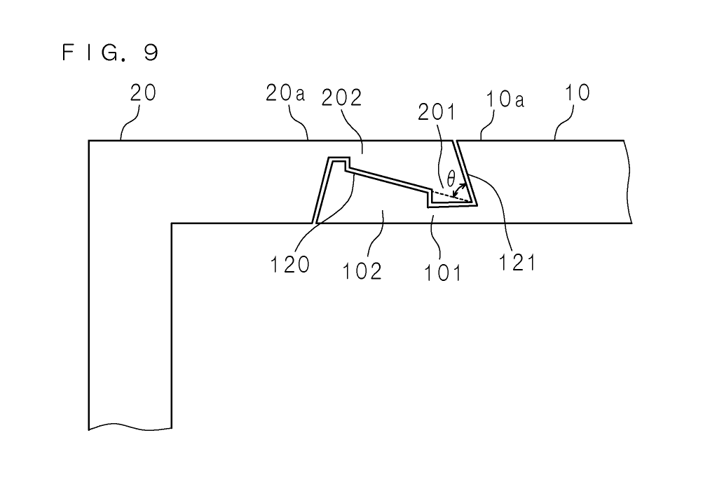

FIG. 9 is a schematic view illustrating the third example of a fitting part between the terminal fixing part 20 and the translucent cover 10. As illustrated in FIG. 9, the translucent cover 10 includes a fitted part at an end thereof, and the fitted part has a thin first fitted part 101 and a thick second fitted part 102 extending from the first fitted part 101 to the end side. Moreover, the terminal fixing part 20 includes a fitting part to be fitted with the fitted part of the translucent cover 10, and the fitting part has a thick first fitting part 201 to be fitted with the first fitted part 101 and a thin second fitting part 202 to be fitted with the second fitted part 102.

Further, a first contact surface 120 where the second fitted part 102 is in contact with the second fitting part 202 is inclined with respect to the longitudinal direction of the translucent cover 10, while a second contact surface 121 where the translucent cover 10 is in contact with the terminal fixing part 20 at the side of outer circumferences 10a and 20a is included with respect to the first contact surface 120 so as to form an acute angle θ.

Accordingly, even if moisture such as waterdrops adhered to the outer circumferences of the translucent cover 10 and terminal fixing part 20 intrudes into a gap between the translucent cover 10 and terminal fixing part 20, the contact surface 120 is inclined with respect to the horizontal direction (lateral direction) like an ascending slope along the intruding direction of moisture in the state where the light source device 100 is attached to an illumination apparatus, which can prevent the moisture from intruding into the translucent cover 10 and terminal fixing part 20.

Furthermore, in the state where the terminal fixing part 20 is located below the translucent part 10, the contact surface 121 is inclined like an ascending slope along the intruding direction of moisture, which can prevent the moisture from intruding into the translucent cover 10 and terminal fixing part 20. Likewise, in the state where the translucent cover 10 is located below the terminal fixing part 20, the contact surface 120 is inclined like an ascending slope along the intruding direction of moisture, which can prevent the moisture from intruding into the translucent cover 10 and terminal fixing part 20.

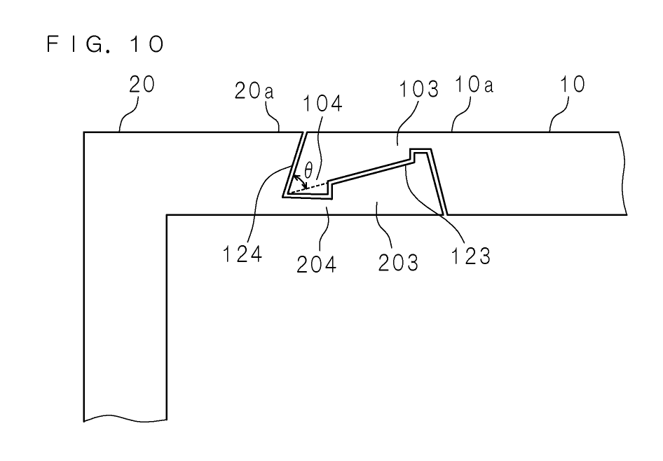

FIG. 10 is a schematic view illustrating the fourth example of a fitting part between the terminal fixing part 20 and the translucent cover 10. As illustrated in FIG. 10, the translucent cover 10 includes a fitted part at an end thereof, and the fitted part has a thin first fitted part 103 and a thick second fitted part 104 extending from the first fitted part 103 to the end side. Moreover, the terminal fixing part 20 includes a fitting part to be fitted with the fitted part of the translucent cover 10, and the fitting part has a thick first fitting part 203 to be fitted with the first fitted part 103 and a thin second fitting part 204 to be fitted with the second fitted part 104.

Further, a first contact surface 123 where the second fitted part 104 is in contact with the second fitting part 204 is inclined with respect to the longitudinal direction of the translucent cover 10, while a second contact surface 124 where the translucent cover 10 is in contact with the terminal fixing part 20 at the side of outer circumferences 10a and 20a is included with respect to the first contact surface 123 to form an acute angle θ.

Accordingly, as in the third example illustrated in FIG. 9, even if moisture such as waterdrops adhered to the outer circumferences of the translucent cover 10 and terminal fixing part 20 intrudes a gap between the translucent cover 10 and terminal fixing part 20, the contact surface 123 is inclined with respect to the horizontal direction (lateral direction) like an ascending slope along the intruding direction of moisture in the state where the light source device 100 is attached to an illumination apparatus, which can prevent the moisture from intruding into the translucent cover 10 and terminal fixing part 20.

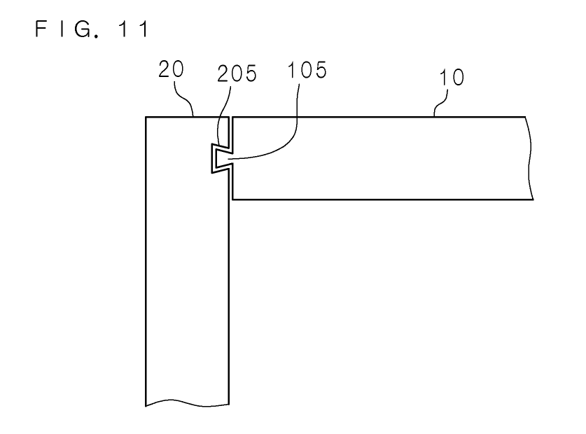

FIG. 11 is a schematic view illustrating the fifth example of a fitting part between the terminal fixing part 20 and the translucent cover 10. As illustrated in FIG. 11, the translucent cover 10 includes a fitted part 105 at an end thereof. Moreover, the terminal fixing part 20 includes a fitting part 205 to be fitted onto the fitted part 105 of the translucent cover 10. The fitted part 105 is, for example, a convex part formed along an end surface of the translucent cover 10, whereas the fitting part 205 is a concave part formed along the outer circumference of the terminal fixing part 20. It is also possible to form a concave part along an end surface of the translucent cover 10 and a convex part along the outer circumference of the terminal fixing part 20. Moreover, the fitted part 105 may be formed to have a tapered shape spreading toward the outer side.

By the configuration illustrated in FIG. 11, the terminal fixing part 20 can be attached to the translucent cover 10 without the use of an adhesive or a component such as a screw, thereby reducing the number of assembling works and enhancing the assembling performance. Moreover, in the fifth example, as the translucent cover 10 extends to have a length approximately equal to the total length of the light source device 100, a light emitting region substantially equal to those in the first to fourth examples can be formed even if the terminal fixing part 20 is formed with a non-translucent member. It is to be noted that the method of attaching the terminal fixing parts 20 and 30 to the translucent cover 10 is not limited to the method of using a fitting structure as described in the first to fifth examples above, but an attachment method using a fixing member such as a screw may also be employed.

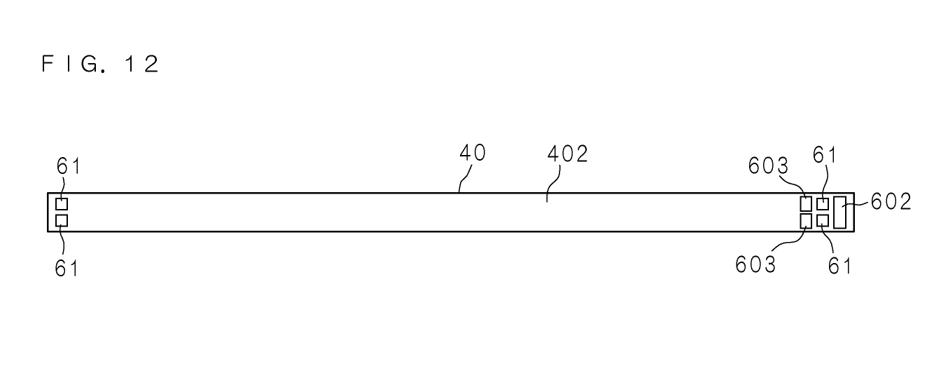

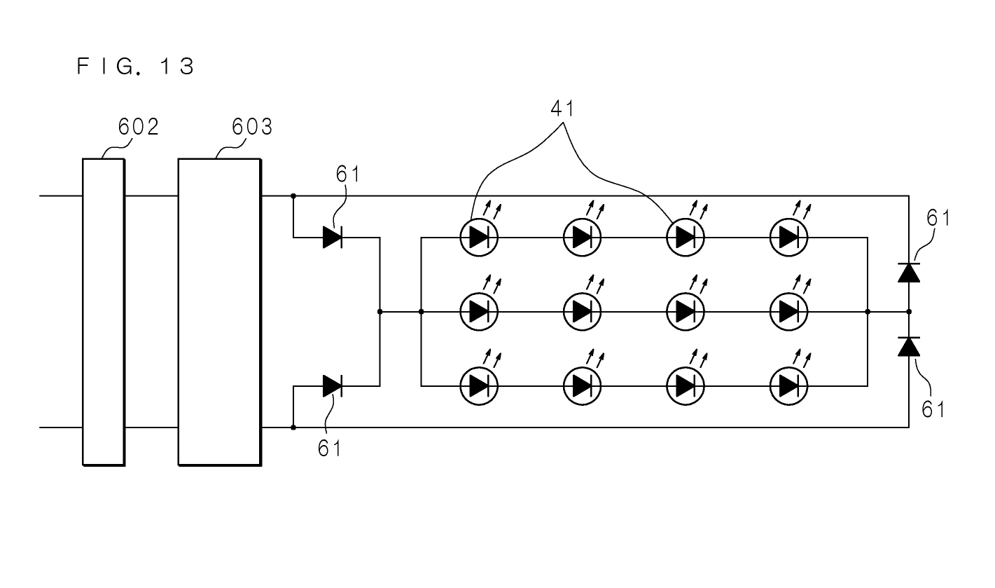

Next, another example of the arrangement of circuit components in the light source device 100 according to the present embodiment will be described. FIG. 12 is a plan view illustrating another example of another surface side of the substrate 40, and FIG. 13 is a schematic view illustrating an example of a layout of the substrate 40. The circuit components 60 include, for example, four diodes (rectifying elements) 61 constituting a diode bridge, protection components 603 such as a fuse, varistor, resistance and the like, and a connecter 602.

The diode 61 consumes power represented by the product of forward current If and forward voltage Vf, and serves as a heat generating source by such power consumption. Here, a plurality of diodes 61 are separately provided at both ends of the substrate 40. In the example shown in FIGS. 12 and 13, four diodes 61 are divided into two sets and two diodes 61 are located at each end of the substrate 40. More specifically, as illustrated in FIG. 13, a plurality of LED modules 41 are arranged on the substrate, and two diodes 61 are located at the input side (position close to the protection components 603 and connecter 602) of the LED modules 41. Furthermore, at the output side of the LED modules 41, i.e. a position farther than the protection component 603 or connector 602 with respect to the LED modules 41, two diodes 61 are arranged, so that the four diodes 61 are divided into two sets and separately arranged. The plurality of diodes 61 are divided to be provided on the input sides and the output sides of the LED modules 41, so that the diodes 61 can separately be arranged on the substrate 40. Accordingly, heat generating sources are not concentrated at one end of the substrate 40 but are separately provided at both ends thereof, which allows for uniform temperature rise. Furthermore, since the diodes 61 are separated which facilitates the arrangement of circuit components on the rear surface 402 of the substrate 40, the front surface 401 of the substrate 40 may efficiently be utilized so that the LED modules 41 may easily be mounted at the ends of substrate 40.

Furthermore, as illustrated in FIG. 13, a plurality of diodes 61 are separately provided at both ends of the substrate 40, so that current patterns (electric paths of current) for feeding current to the LED modules 41 can be arranged uniformly on the entire substrate 40. Accordingly, the diodes 61 can separately be arranged on the rear surface 402 of the substrate 40.

It is to be noted that the diodes 61 may separately be provided on the substrate 40 only to suppress concentration of heat, and the arrangement of diodes 61 is not limited to the examples shown in FIGS. 12 and 13. For example, the diodes 61 may separately be arranged at a middle part and one end of the substrate 40.

If all the circuit components 60 are concentrated at one end of the substrate 40, a large space is required for placing the circuit components 60 in the space on the rear surface 402 side of the substrate 40. It is, however, possible to reduce the space required for arrangement of circuit components 60 by separately positioning a part of the circuit components 60 (e.g., diodes 61) on the substrate 40, facilitating mounting or arrangement of the circuit components 60 to the substrate 40.

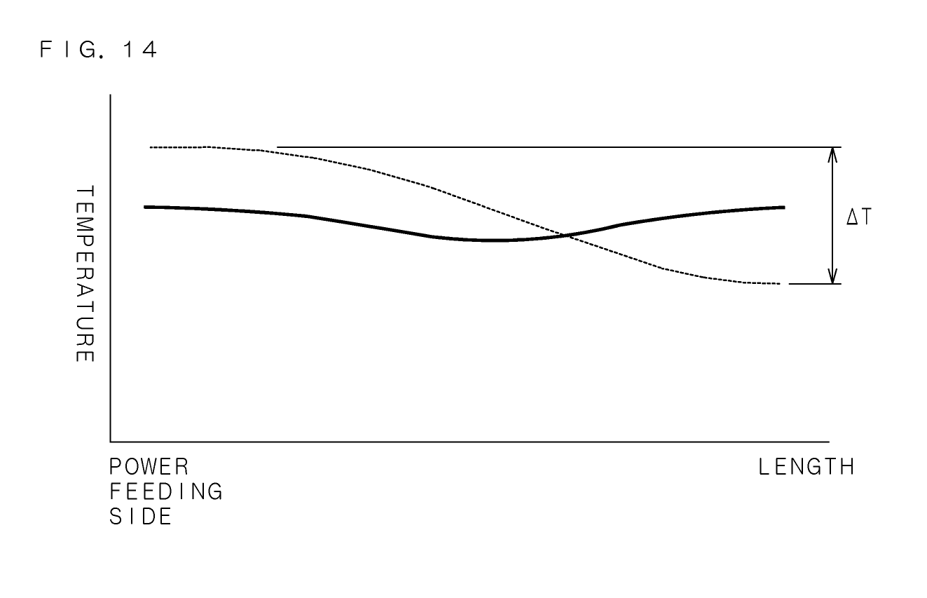

FIG. 14 is a schematic view illustrating an example of a temperature distribution for the translucent cover 10. In FIG. 14, the horizontal axis indicates the length from the power feeding side (i.e. fixing terminal part 30), whereas the vertical axis indicates the temperature of the translucent cover 10. The dashed line in the graph shows a conventional example provided for comparison where one diode bridge is located at one end of the substrate 40, whereas the solid line in the graph shows an example where a plurality of diodes 61 are separately provided at both ends of the substrate 40.

As can be seen from FIG. 14, since the diodes 61 as heat generating sources are separately provided at both ends of the substrate 40, a large temperature difference A as in the conventional case is not caused, and thus bias in temperature distribution can be reduced. Moreover, the separately-provided diodes 61 at both ends of the substrate 40 allow the path for current flowing in the LED modules 41 to be uniformly distributed across the entire substrate 40, which can make the temperature distribution uniform in the longitudinal direction of the translucent cover 10. Furthermore, as the temperature distribution can be made uniform, deformation (warping) of the translucent cover 10 due to a temperature difference can also be suppressed. In particular, in the case of the present embodiment, as the circuit components 60 are located at the portion on the rear surface 402 opposed to the LED module 41 at an end of the substrate 40, heat tends to be concentrated to that end. It is, however, possible to suppress the concentration of heat at the end because a part of the diodes 61, which are heat generating sources, can be separated from the other diodes 61.

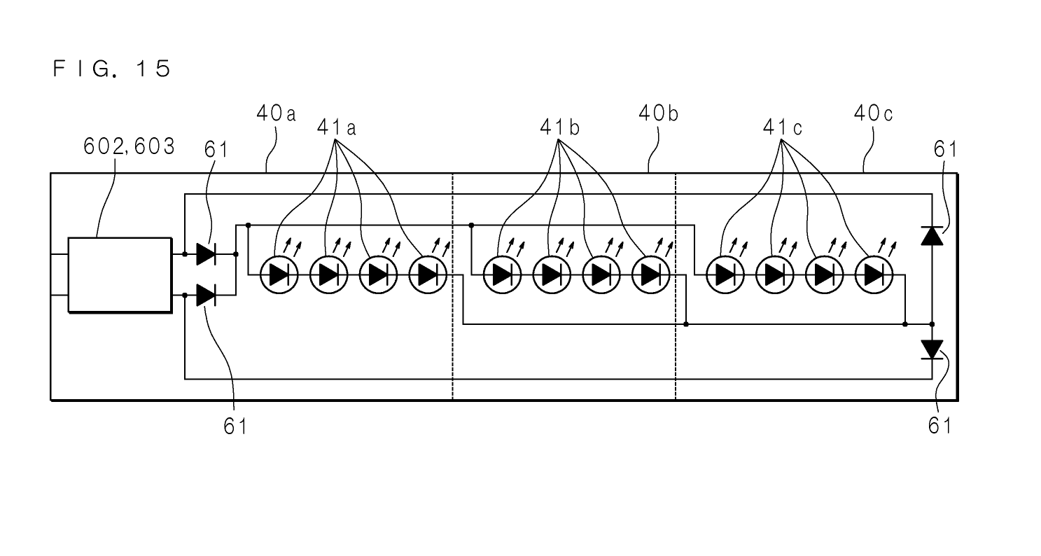

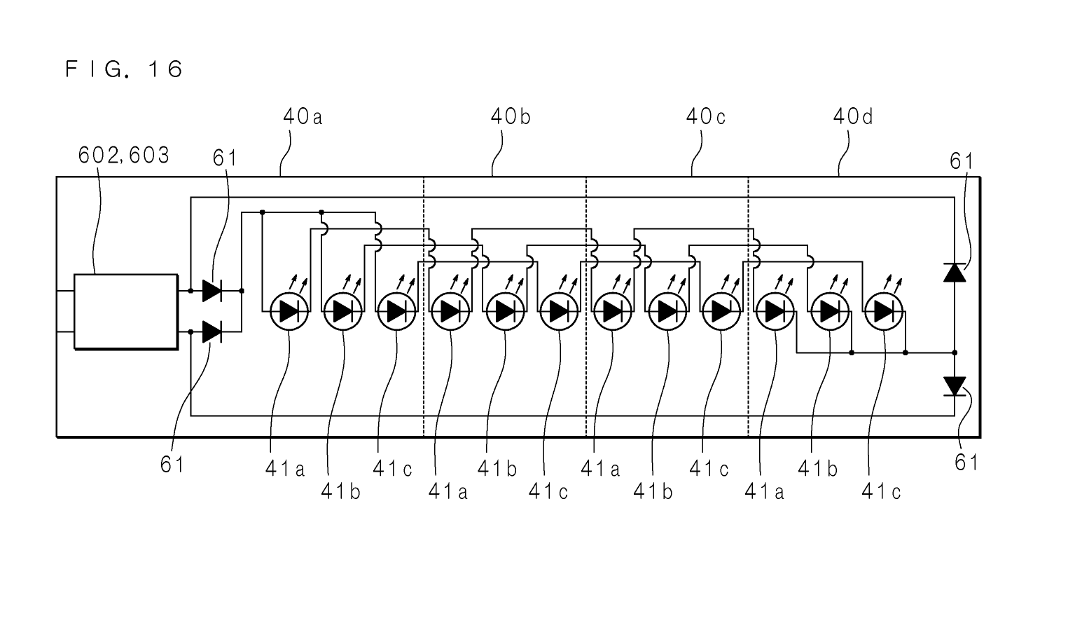

Next, an example for mounting an LED module to a substrate in consideration of the forward voltage characteristic will be described. FIG. 15 is a schematic view illustrating an example of a layout for mounting an LED module to a substrate as a comparative example, and FIG. 16 is a schematic view illustrating an example of a layout for mounting an LED module to a substrate according to the present embodiment. As illustrated in FIG. 15, it is assumed, for convenience, that the substrate 40 is constituted by three substrates 40a, 40b and 40c. It is also assumed that the LED module 41 is categorized into three types of LED modules 41a, 41b and 41c according to the forward voltage characteristics. Assuming that the respective forward voltage values of the LED modules 41a, 41b and 41c are Vfa, Vfb and Vfc; Vfa<Vfb<Vfc is satisfied. Note that the number of categories according to the forward voltage is not limited to three.

In the case where LED modules are mounted on a substrate, as LED modules having substantially the same forward voltage characteristic (ones categorized in the same type) are often used together, the LED modules mounted on one substrate have the same forward voltage characteristic in most cases. If, however, a plurality of substrates are inserted into the translucent cover 10, the LED modules mounted on the substrates may not have the same forward voltage characteristic, and the LED modules categorized as different types are mixed in different substrates. Such a case is illustrated in FIG. 15.

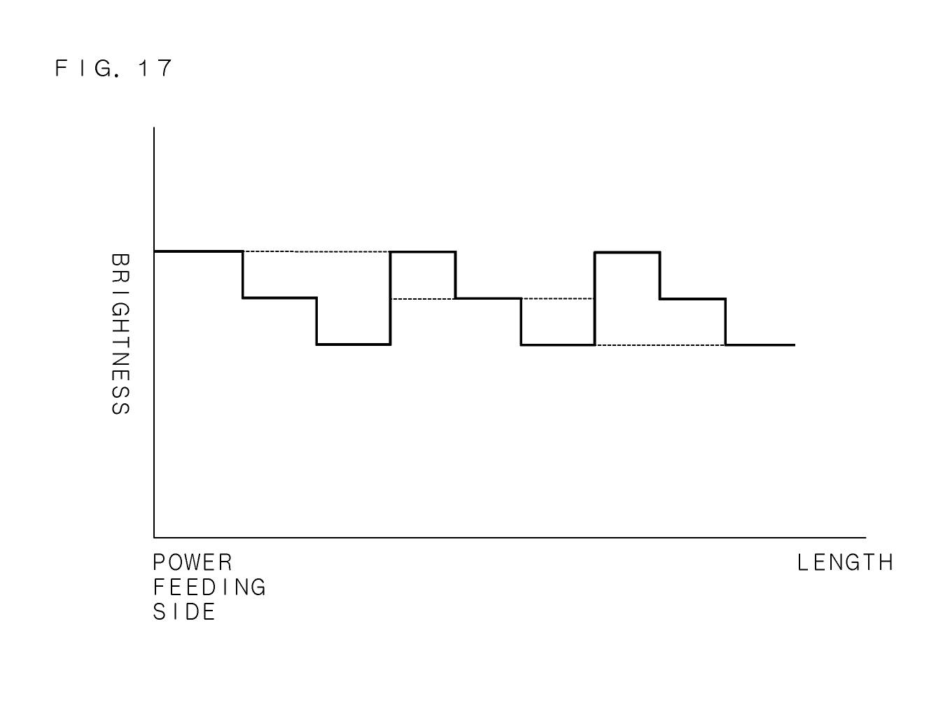

FIG. 17 is a schematic view illustrating an example of brightness distribution for the translucent cover 10. In FIG. 17, the horizontal axis indicates the length from the power feeding side (i.e. fixing terminal part 30), whereas the vertical axis indicates the brightness. The dashed line in the graph shows the distribution of brightness in the layout for mounting the LED modules 41a, 41b and 41c illustrated in FIG. 15. Since the forward voltage Vfa of LED module 41a is the smallest, the largest current flows in the LED module 41a in the case where the four serially-connected LED modules 41a, 41b and 41c are connected in parallel with one another. Moreover, the forward voltage Vfa of the LED module 41c is the largest, the smallest current flows in the LED module 41c. As a result, the brightness of the LED module 41a is the highest whereas that of the LED module 41c is the lowest.

Next, a case according to the present embodiment will be described with reference to FIG. 16. As illustrated in FIG. 16, it is assumed, for convenience, that the substrate 40 is constituted by four substrates 40a, 40b, 40c and 40d. It is also assumed that the LED module 41 is categorized into three types of LED modules 41a, 41b and 41c according to the forward voltage characteristics. Assuming that the respective forward voltage values of the LED modules 41a, 41b and 41c are Vfa, Vfb and Vfc; Vfa<Vfb<Vfc is satisfied. Note that the number of substrates is not limited to four but may appropriately be determined in accordance with the number of categories according to the forward voltage. Furthermore, another number may appropriately be employed for the number of serial or parallel connections of LED modules.

As illustrated in FIG. 16, three types of LED modules 41a, 41b and 41c are mounted on each of the substrates 40a, 40b, 40c and 40d. A current pattern (wiring pattern) is then formed such that the four LED modules 41a mounted on the respective substrates 40a, 40b, 40c and 40d are connected in series. Also for the LED modules 41b and 41c, a current pattern (wiring pattern) is similarly formed such that the four LED modules mounted on the respective substrates 40a, 40b, 40c and 40d are connected in series.

By the configuration illustrated in FIG. 16, in each of the substrates 40a, 40b, 40c and 40d, the LED module 41a has the highest brightness whereas the LED module 41c has the lowest brightness among the three types of LED modules 41a, 41b and 41c with different forward voltage values. However, as indicated by the solid line in the graph of FIG. 17, comparing the substrates 40a, 40b, 40c and 40b with one another, the brightness distribution may be the same among the substrates.

Furthermore, the substrates 40a, 40b, 40c and 40d may have the same distribution of heat generation, the temperature distribution in the longitudinal direction of the translucent cover 10 may be made uniform as in the case illustrated in FIG. 14, for example. It is also possible to make the temperature distribution uniform, which can also suppress the deformation (warping) due to the difference in the temperature of the translucent cover 10.

While the configuration using an LED module as a light source is employed in the embodiment described above, the light source is not limited to the LED module but may also be an organic EL.

The configurations in the examples described above can be combined with one another, and the combination thereof may form a new technical feature. As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims. (US Only)

1-5. (canceled)

6. A light source device, comprising a substrate on which a plurality of light sources are mounted, and a tubular translucent cover in which the substrate is installed, wherein
a part of the plurality of light sources is mounted on one surface of an end of the substrate,
a circuit component is provided on a side of another surface at the end of the substrate, and
at an end provided with the circuit component of the translucent cover, a terminal fixing part having translucency to which a power feeding terminal or a ground terminal is fixed.

7. The light source device according to claim 6, wherein
the circuit component is mounted on said another surface at the end of the substrate,
the light source device comprises a placement plate on which the substrate is placed, and
the placement plate has an opening at a portion opposed to the circuit component.

8. The light source device according to claim 6, wherein
the translucent cover includes a fitted part at an end of the translucent cover,
the terminal fixing part includes a fitting part to be fitted with the fitted part,
the fitted part has a thin first fitted part and a thick second fitted part extending from the first fitted part, and
the fitting part has a thick first fitting part and a thin second fitting part to be fitted with the first fitted part and the second fitted part, respectively.

9. The light source device according to claim 7, wherein
the translucent cover includes a fitted part at an end of the translucent cover,
the terminal fixing part includes a fitting part to be fitted with the fitted part,
the fitted part has a thin first fitted part and a thick second fitted part extending from the first fitted part, and
the fitting part has a thick first fitting part and a thin second fitting part to be fitted with the first fitted part and the second fitted part, respectively.

10. The light source device according to claim 6, wherein
the circuit component has a plurality of rectifying elements, and
the plurality of rectifying elements are separately provided at an input side and an output side of the light source on the substrate.

11. The light source device according to claim 7, wherein
the circuit component has a plurality of rectifying elements, and
the plurality of rectifying elements are separately provided at an input side and an output side of the light source on the substrate.
